(19) United States
(12) Patent Application Publication
(10) Pub. No.: US 2021/0106058 A1
(43) Pub. Date: Apr. 15, 2021

(54) Aerosol Generating System

(71) Applicant: JT International S.A., Geneva (CH)

(72) Inventors: Andrew Robert John Rogan, Forres (GB); Takashi Hasegawa, Tokyo (JP); Eduardo Jose Garcia Garcia, Grand-Sacconex (CH)

(73) Assignee: JT International S.A., Geneva (CH)

(21) Appl. No.: 17/046,625

(22) PCT Filed: May 15, 2019
(86) PCT No.: PCT/EP2019/062503

§ 371 Date: Oct. 9, 2020

(30) Foreign Application Priority Data
May 21, 2018 (EP) 18173406.2

(51) Int. Cl. A24F 40/465; A24F 40/53; A24F 40/20

(52) U.S. Cl. CPC A24F 40/465; A24F 40/20; A24F 40/53

(57) ABSTRACT

An aerosol generating system includes an aerosol generating device having an aerosol generating space for receiving aerosol generating material, an induction coil extending around the aerosol generating space and a controller. The aerosol generating system further includes a susceptor which is inductively heatable in the presence of a time varying electromagnetic field. The susceptor is separable from aerosol generating material located, in use, in the aerosol generating space and includes a tubular member positioned, in use, in the aerosol generating space. The aerosol generating material is located, in use, inside and outside of the tubular member.

### TECHNICAL FIELD

The present disclosure relates to an aerosol generating system, and more particularly to an aerosol generating system for generating an aerosol for inhalation by a user.

### TECHNICAL BACKGROUND

Devices which heat, rather than burn, an aerosol generating material to produce an aerosol for inhalation have become popular with consumers in recent years.

Such devices can use one of a number of different approaches to provide heat to the aerosol generating material. One such approach is to provide an aerosol generating device which employs an induction heating system and into which an aerosol generating article, comprising aerosol generating material, can be removably inserted by a user. In such a device, an induction coil is provided with the device and an induction heatable susceptor is provided with the aerosol generating material. Electrical energy is provided to the induction coil when a user activates the device which in turn generates an alternating electromagnetic field. The susceptor couples with the electromagnetic field and generates heat which is transferred, for example by conduction, to the aerosol generating material and an aerosol is generated as the aerosol generating material is heated.

Embodiments of the present disclosure seek to provide an improved aerosol generating system.

### SUMMARY OF THE DISCLOSURE

According to a first aspect of the present disclosure, there is provided an aerosol generating system comprising:
an aerosol generating device comprising:
   an aerosol generating space for receiving aerosol generating material;
   an induction coil extending around the aerosol generating space; and
   a controller;
a susceptor which is inductively heatable in the presence of a time varying electromagnetic field;
wherein the susceptor is separable from aerosol generating material located, in use, in the aerosol generating space and comprises a tubular member positioned, in use, in the aerosol generating space, and wherein the aerosol generating material is located, in use, inside and outside of the tubular member.

The system may comprise the aerosol generating material in the aerosol generating space and inside/outside of the tubular member of the susceptor.

The tubular member has an outer cylindrical surface and an inner cylindrical surface. The outer and inner cylindrical surfaces are continuous surfaces.

The aerosol generating device is adapted to heat the aerosol generating material, without burning the aerosol generating material, to volatise at least one component of the aerosol generating material and thereby generate an aerosol for inhalation by a user of the aerosol generating system.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

The susceptor is reusable and is a separate component to the aerosol generating material. A susceptor does not, therefore, need to be provided with the aerosol generating material making it easier and cheaper to manufacture than, for example, an aerosol generating article which incorporates aerosol generating material and one or more induction heatable susceptors integrated into the aerosol generating article. The risk of contamination, e.g., metal contamination, of the aerosol generating material by the induction heatable susceptor during storage is also eliminated or at least reduced because the induction heatable susceptor is brought into contact with the aerosol generating material only at the point of use, when aerosol generating material is positioned in the aerosol generating space of the aerosol generating device.

Positioning the susceptor in the aerosol generating space allows the positional relationship between the susceptor and the induction coil to be fixed, thereby ensuring optimal coupling between the electromagnetic field produced by the induction coil and the susceptor.

The provision of a susceptor in the form of a tubular member and of aerosol generating material located inside and outside of the tubular member provides for optimum heat transfer from the susceptor to the aerosol generating material. This in turn provides for optimum heating of the aerosol generating material and ensures that the characteristics of the aerosol generated during use of the aerosol generating system are optimised.

The aerosol generating device may include air inlet ports which direct air flowing into the aerosol generating space both to the interior of the tubular member and to the exterior of the tubular member. The air inlet ports ensure that air is directed to the aerosol generating material positioned both inside and outside the tubular susceptor, thereby maximising the generation and delivery of aerosol from the aerosol generating space through an air outlet of the aerosol generating device.

The susceptor may be removably mounted in the aerosol generating space. With this arrangement, the susceptor is provided as a separate component to the other components of the aerosol generating device. The susceptor can, therefore, be easily replaced at appropriate time intervals, for example if it is damaged, soiled or contaminated, for example with deposits of aerosol generating material following a period of use.

The aerosol generating device may include a connector for removably mounting the susceptor, for example in the aerosol generating space. The provision of a connector allows for easy removable mounting of the susceptor and may advantageously ensure an appropriate positional relationship between the susceptor and the induction coil.

The controller may be configured to detect the mounting of the susceptor in the aerosol generating space. The controller may be configured to indicate a timing change of the susceptor. For example, the controller may be configured to detect a predetermined power level supplied to the induction coil and to indicate a timing change of the susceptor based on the detected power level.

The controller may be configured to detect the positioning of a new susceptor in the aerosol generating space. The controller may be configured to indicate a timing change of the susceptor after detecting the positioning of a new susceptor in the aerosol generating space, for example based on the detected power level. Alternatively or in addition, the controller may be configured to cease power supply to the induction coil after detecting the positioning of a new susceptor in the aerosol generating space and based on the detected power level. This arrangement ensures that the reusable susceptor is replaced at appropriate time intervals to ensure optimum heating of the aerosol generating material.

In an embodiment, the controller may be configured to detect the positioning of a new susceptor in the aerosol generating space by detecting a characteristic associated with the susceptor. The characteristic could be an identification characteristic and could comprise an identification signal, for example emitted by a RFID tag associated with the susceptor. Alternatively, the user could indicate that the susceptor has been replaced with a new susceptor, e.g. by performing a predetermined action such as a button press or a series of button presses, etc.

The controller may be configured to detect the consumption of aerosol generating material by detecting at least one of the following:
the number of puffs;
the length of the total puff period;
the number of placements of aerosol generating material in the aerosol generating space;
the movement of one or more components of the aerosol generating device that are required to allow the placement of aerosol generating material in the aerosol generating space.

The aerosol generating device may include a sensor, for example an optical sensor, to enable the controller to detect the placement of aerosol generating material in the aerosol generating space.

The aerosol generating device may include one or more sensors to detect the movement of the one or more component parts, such as a mouthpiece or cover to allow access to the aerosol generating space, to enable the controller to detect the movement of the one or more components of the aerosol generating device.

The controller may be configured to detect the level of consumption of aerosol generating material and to indicate a timing change of the susceptor (that is to indicate that it is time to change the susceptor or to indicate the remaining “life” of the susceptor before it should optimally be changed, etc.) based on the detected consumption level and/or to cease power supply to the induction coil based on the detected consumption level. The controller may be configured to detect the level of consumption of aerosol generating material after detecting the positioning of a new susceptor in the aerosol generating space. The controller may be further configured to indicate a timing change of the susceptor based on the detected consumption level after detecting the positioning of a new susceptor in the aerosol generating space and/or to cease power supply to the induction coil based on the detected consumption level after detecting the positioning of a new susceptor in the aerosol generating space and until the positioning of a new susceptor in the aerosol generating space is detected. Again, this arrangement ensures that the reusable susceptor is replaced at appropriate time intervals to ensure optimum heating of the aerosol generating material.

The susceptor may be positioned in the aerosol generating space so that a longitudinal axis of the susceptor is substantially aligned with a longitudinal axis of the induction coil. This positional relationship ensures optimum coupling of the electromagnetic field generated by induction coil with the susceptor.

The aerosol generating space may comprise a cavity.

The aerosol generating material may comprise a non-liquid aerosol generating material.

The aerosol generating material may comprise one or more selected from the group consisting of granules, particles, gel, strips, loose leaves, cut filler, pellets, powder, shreds, strands, foam material and sheets. Thus, common and widely available aerosol generating materials can be used for aerosol generation. The aerosol generating material may comprise plant derived material and in particular, may comprise tobacco.

The aerosol generating material may be provided in a housing connected to a mouthpiece, for example in the form of an aerosol generating article which can be inserted into the aerosol generating space. The housing may, for example, comprise a non-electrically conductive material and may, for example, comprise a paper wrapper. The provision of an aerosol generating article may facilitate use of the aerosol generating system.

The aerosol generating article may be elongate and may be substantially cylindrical. The cylindrical shape of the aerosol generating article with its circular cross-section may advantageously facilitate insertion of the aerosol generating article into the aerosol generating space, in particular when the induction coil is a helical induction coil having a circular cross-section. The ability of the aerosol generating space to receive a substantially cylindrical aerosol generating article to be heated is advantageous as, often, vaporisable aerosol generating substances, and tobacco products in particular, are packaged and sold in a cylindrical form.

The induction coil may be arranged to operate in use with a fluctuating electromagnetic field having a magnetic flux density of between approximately 20 mT and approximately 2.0 T at the point of highest concentration.

The aerosol generating device may include a power source. The power source and the controller may be configured to operate at a high frequency. The power source and controller may be configured to operate at a frequency of between approximately 80 kHz and 500 kHz, possibly between approximately 150 kHz and 250 kHz, and possibly at approximately 200 kHz. The power source and circuitry could be configured to operate at a higher frequency, for example in the MHz range, depending on the type of inductively heatable susceptor that is used.

Whilst the induction coil may comprise any suitable material, typically the induction coil may comprise a Litz wire or a Litz cable.

Whilst the aerosol generating device may take any shape and form, it may be arranged to take substantially the form of the induction coil, to reduce excess material use. As noted above, the induction coil may be substantially helical in shape and may have a circular cross-section, thus the aerosol generating device may be substantially cylindrical and may have a substantially circular cross-section.

The circular cross-section of a helical induction coil facilitates the insertion of aerosol generating material and/or an aerosol generating article into the aerosol generating space and ensures uniform heating of the aerosol generating material and/or the aerosol generating article. The resulting shape of the aerosol generating device is also comfortable for the user to hold.

The susceptor may comprise one or more, but not limited, of aluminium, iron, nickel, stainless steel and alloys thereof, e.g. Nickel Chromium or Nickel Copper. With the application of an electromagnetic field in its vicinity, the susceptor may generate heat due to eddy currents and magnetic hysteresis losses resulting in a conversion of energy from electromagnetic to heat.

The aerosol generating material may comprise an aerosol-former. Examples of aerosol-formers include polyhydric alcohols and mixtures thereof such as glycerine or propylene glycol. Typically, the aerosol generating material may comprise an aerosol-former content of between approximately 5% and approximately 50% on a dry weight basis. In some embodiments, the aerosol generating material may comprise an aerosol-former content of approximately 15% on a dry weight basis.

Upon heating, the aerosol generating material may release volatile compounds. The volatile compounds may include nicotine or flavour compounds such as tobacco flavouring.

### BRIEF DESCRIPTION OF THE DRAWINGS

FIG. 1 is diagrammatic cross-sectional view of a first embodiment of an aerosol generating system prior to placement of aerosol generating material in the aerosol generating space;

FIGS. 2 and 3 are diagrammatic cross-sectional views of the aerosol generating system of FIG. 1 with the mouthpiece removed and illustrating the placement of aerosol generating material in the aerosol generating space;

FIG. 4 is a diagrammatic cross-sectional view similar to FIGS. 1 to 3 of a second embodiment of an aerosol generating system and illustrating an aerosol generating article, comprising aerosol generating material, for placement in the aerosol generating space;

FIG. 5 is a diagrammatic cross-sectional view of a third embodiment of an aerosol generating system prior to placement of aerosol generating material in the aerosol generating space; and

FIG. 6 is a diagrammatic cross-sectional view of a fourth embodiment of an aerosol generating system prior to placement of aerosol generating material in the aerosol generating space.

### DETAILED DESCRIPTION OF EMBODIMENTS

Embodiments of the present disclosure will now be described by way of example only and with reference to the accompanying drawings.

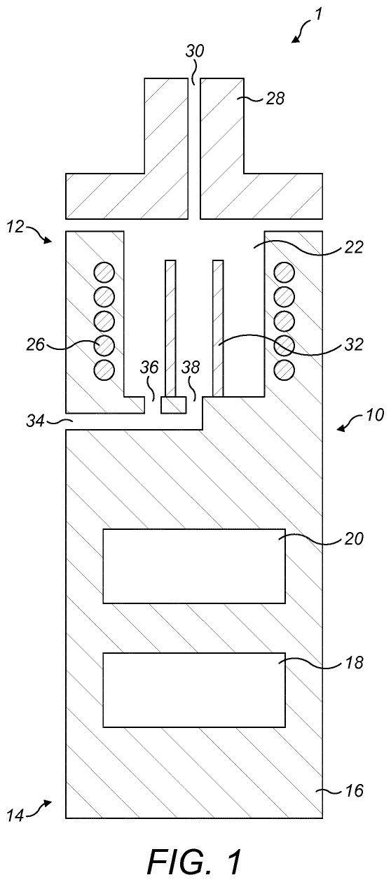

Referring initially to FIGS. 1 to 3, there is shown diagrammatically a first embodiment of an aerosol generating system 1. The aerosol generating system 1 comprises an aerosol generating device 10 having a proximal end 12 and a distal end 14. The aerosol generating device 10 comprises a device body 16 which includes a power source 18 and a controller 20 which may be configured to operate at high frequency. The power source 18 typically comprises one or more batteries which could, for example, be inductively rechargeable.

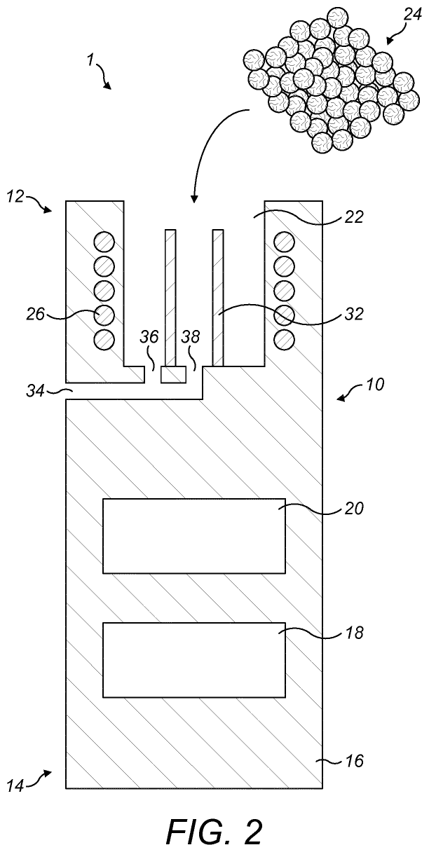

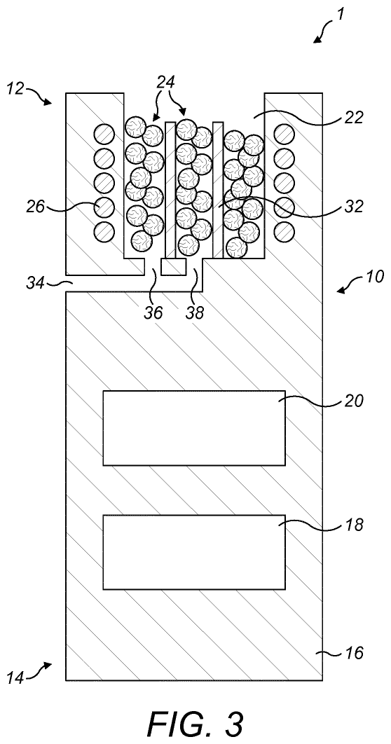

The aerosol generating device 10 is generally cylindrical and comprises a generally cylindrical aerosol generating space 22 formed as a cavity in the device body 16 at the proximal end 12 of the aerosol generating device 10. The aerosol generating space 22 is arranged to receive aerosol generating material 24, as shown in FIGS. 2 and 3, for example in the form of granules, particles, gel, strips, loose leaves, cut filler, pellets, powder, shreds, strands, foam material and sheets.

The aerosol generating device 10 comprises a helical induction coil 26 which has a circular cross-section and which extends around the aerosol generating space 22. The induction coil 26 can be energised by the power source 18 and controller 20. The controller 20 includes, amongst other electronic components, an inverter which is arranged to convert a direct current from the power source 18 into an alternating high-frequency current for the induction coil 26.

The aerosol generating device 10 comprises a mouthpiece 28 which is removably mountable on the device body 16 at the proximal end 12 and through which a user may inhale vapour generated during use of the device 10. The mouthpiece 28, which is shown diagrammatically in FIG. 1, includes an air outlet 30 which allows aerosol generated during use of the device 10 to flow from the aerosol generating space 22 and into the mouth of a user.

The aerosol generating system 1 comprises a tubular susceptor 32 which is formed of material that is inductively heatable in the presence of a time varying electromagnetic field generated by the induction coil 26. The susceptor 32 is positioned in use concentrically in the aerosol generating space 22. The susceptor 32 can be permanently mounted in the aerosol generating space 22, for example as an integral component of the aerosol generating device 10, or can be removably mounted in the aerosol generating space 22, for example by a suitable connector (not shown). As will be apparent from FIG. 1, the susceptor 32 is positioned in the aerosol generating space 22 so that its longitudinal axis is substantially aligned with a longitudinal axis of the induction coil 26. Aerosol generating material 24 is located in use both inside and outside of the tubular susceptor, as can be clearly seen in FIG. 3.

In the case where the susceptor 32 is a separate element which is removably connectable to the aerosol generating device 10 in the aerosol generating space 22, it may be securely removably attached by a suitable connection mechanism. For example, the device 10 may include a cooperating recess into which an end of the susceptor 32 may be snugly fitted with a friction fit or with a screw fit (if supplied with a screw ridge or groove cooperating with a matching groove or ridge formed in the recess) or with a bayonetted fitting. Additionally or alternatively, the device 10 may include a magnet for securely attaching the susceptor 32 in a well-defined position within the aerosol generating space 22.

When a time varying electromagnetic field is produced in the vicinity of the susceptor 32 by the induction coil 26, heat is generated in the susceptor 32 due to eddy currents and/or magnetic hysteresis losses and the heat is transferred from the susceptor 32 to the aerosol generating material 24 located both inside and outside of the tubular susceptor 32 to heat the aerosol generating material 24 without burning it and to thereby generate an aerosol for inhalation by a user. The tubular susceptor 32 is in contact over substantially its entire inner and outer surfaces with the aerosol generating material 24, thus enabling heat to be transferred directly, and therefore efficiently, from the susceptor 32 to the aerosol generating material 24.

The aerosol generating device 10 includes an air inlet 34 which delivers air to the aerosol generating space via inlet ports 36, 38 which are positioned so that they direct the air both to the interior of the tubular susceptor 32 and to the exterior of the tubular susceptor 32. It will be understood that this arrangement maximises the generation and delivery of aerosol from the aerosol generating space 22 through the air outlet 30.

As noted above, the mouthpiece 28 is conveniently removable from the device body 16 to allow access to the aerosol generating space 22. Thus, the mouthpiece 28 can be removed to allow aerosol generating material 24 to be inserted into the aerosol generating space 22 and subsequently reattached to the device body 16 so that the aerosol generating system 1 can be used for aerosol generation. After a period of use, the mouthpiece 28 can be removed again to allow the used aerosol generating material 24 to be removed and to enable the placement of further aerosol generating material 24 in the aerosol generating space 22. In addition, it will be understood that removal of the mouthpiece 28 also allows access to the susceptor 32 so that, in the case of a removably mounted susceptor 32, it can be removed and replaced if appropriate.

In some embodiments which utilise a removably mounted susceptor 32, the controller 20 can be configured to detect the mounting of a new susceptor 32 in the aerosol generating space 22, for example by detecting an identification characteristic associated with the susceptor 32 or as a result of the user indicating that the susceptor 32 has been replaced with a new susceptor 32 (e.g. by performing a predetermined button press or series of presses, etc.). After detecting the mounting of a new susceptor 32, the controller 20 can be further configured to detect the power level supplied to the induction coil 26 and to indicate a timing change of the susceptor 32 (that is to indicate that it is time to change the susceptor 32 or to indicate the remaining “life” of the susceptor 32 before it should optimally be changed, etc.) based on the detected power level and/or to cease power supply to the induction coil 26 based on the detected power level until the controller 20 detects that another new susceptor 32 has been positioned in the aerosol generating space 22. In particular, the device 10 can monitor the total energy supplied to the induction coil 26 over time since inserting a new susceptor 32 (by integrating the power supplied to the coil 26 over time) and can determine that after a predetermined amount of energy has been supplied to the coil 26 it is time for the susceptor 32 to be changed. A notification that the susceptor 32 should be changed can be provided to the user via any suitable means—e.g. by a warning light flashing in a predetermined pattern, etc.

In some embodiments, the controller 20 can be configured to detect the consumption of aerosol generating material 24 by detecting one or more of: the number of puffs; the length of the total puff period; the number of placements of aerosol generating material 24 in the aerosol generating space 22, for example using an optical sensor (not shown);

and the movement of one or more components of the aerosol generating device 10, for example the movement of the mouthpiece 28, that are required to allow the placement of aerosol generating material 24 in the aerosol generating space 22. Additionally it should be noted that the techniques for determining that a susceptor 32 should be changed could generally also be used for detecting the amount of consumption of aerosol material 24 and vice versa as will be apparent to a person skilled in the art.

In some embodiments, the controller 20 can advantageously be configured to detect the level of consumption of aerosol generating material 24 after detecting the positioning of a new susceptor 32 in the aerosol generating space 22, and can be configured to indicate a timing change of the susceptor 32 based on the detected consumption level and/or to cease power supply to the induction coil 26 based on the detected consumption level until the controller 20 detects that another new susceptor 32 has been positioned in the aerosol generating space 22.

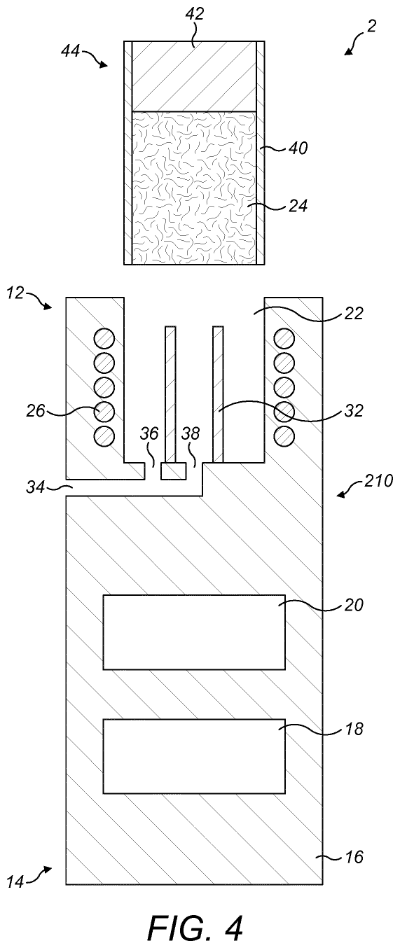

Referring now to FIG. 4, there is shown a second embodiment of an aerosol generating system 2 which is similar to the aerosol generating system 1 illustrated in FIGS. 1 to 3 and in which corresponding elements are designated using the same reference numerals.

The aerosol generating system 2 comprises an aerosol generating device 210 which is identical to the aerosol generating device 10 described above in all respects except that it does not include the removable mouthpiece 28.

In the aerosol generating system 2, the aerosol generating material 24 is provided in a non-electrically conductive housing 40, for example in the form of a paper wrapper, that is connected to a mouthpiece 42. The aerosol generating material 24, the housing 40 and the mouthpiece 42 together constitute an aerosol generating article 44 which can be removably positioned in the aerosol generating space 22. It will be understood that the tubular susceptor 32 penetrates the aerosol generating material 24 and may extend fully into the aerosol generating material 24 when the aerosol generating article 44 is positioned in the aerosol generating space 22, and that the mouthpiece 42 projects from the distal end 12 of the aerosol generating device 210 so that it can be engaged by a user's lips.

The aerosol generating system 2 operates in the same manner as the aerosol generating system 1 described above, so that when a time varying electromagnetic field is produced in the vicinity of the susceptor 32 by the induction coil 26, heat is generated in the susceptor 32 and is transferred from the susceptor 32 to the aerosol generating material 24 located both inside and outside of the tubular susceptor 32 to heat the aerosol generating material 24 without burning it and to thereby generate an aerosol for inhalation by a user. The aerosol generated due to heating of the aerosol generating material 24 is inhaled by a user through the mouthpiece 42.

After a period of use, the aerosol generating article 44 can be removed from the aerosol generating space 22 and a further aerosol generating article 44 can be positioned in the aerosol generating space 22. In addition, it will be understood that removal of the aerosol generating article 44 allows access to the susceptor 32 so that, in the case of a removably mounted susceptor 32, it can be removed and replaced if appropriate.

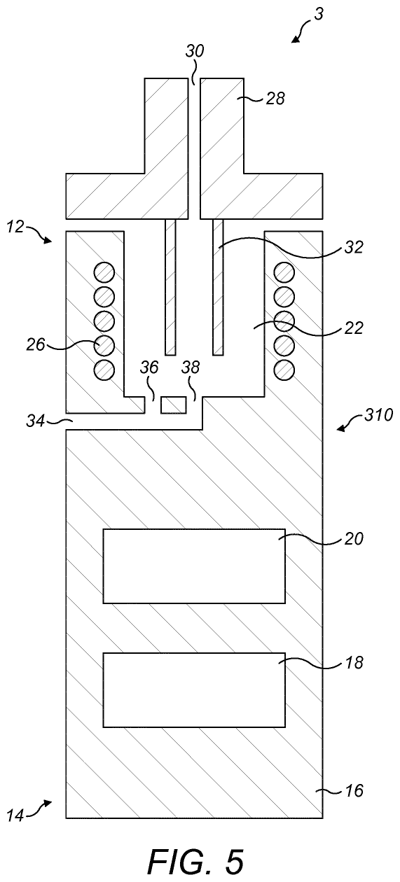

Referring now to FIG. 5, there is shown a third embodiment of an aerosol generating system 3 which is similar to the aerosol generating system 1 illustrated in FIGS. 1 to 3 and in which corresponding elements are designated using the same reference numerals.

The aerosol generating system 3 comprises an aerosol generating device 310 which is identical to the aerosol generating device 10 described above in all respects except that the susceptor 32 is mounted on the mouthpiece 28 and extends from the mouthpiece 28 into the aerosol generating space 22 when the mouthpiece 28 is positioned on the device body 16 at the proximal end 12 of the aerosol generating device 310 as shown in FIG. 5. Thus, the susceptor 32 is removably mounted in the aerosol generating space 22 by virtue of the removable mounting of the mouthpiece 28 on the device body 16 at the proximal end 12 of the aerosol generating device 310.

With this arrangement, the susceptor 32 can be formed with the mouthpiece 28 as an integral component such that replacement of the susceptor 32 will necessitate replacement of the mouthpiece 28. Alternatively, the susceptor 32 can be removably mounted on the mouthpiece 28, for example by a connector (not shown), so that the susceptor 32 can be removed and replaced after a period of use without replacement of the mouthpiece 28.

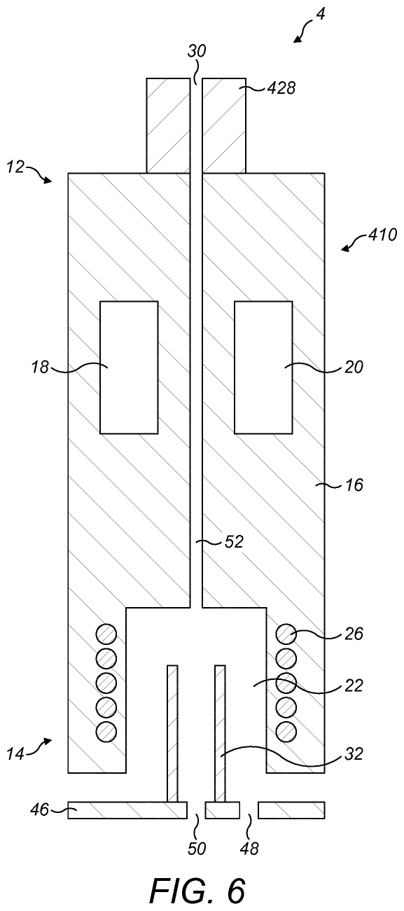

Referring now to FIG. 6, there is shown a fourth embodiment of an aerosol generating system 4 which is similar to the aerosol generating system 1 illustrated in FIGS. 1 to 3 and in which corresponding elements are designated using the same reference numerals.

The aerosol generating system 4 comprises an aerosol generating device 410 having an integrally formed mouthpiece 428 at the proximal end 12 of the aerosol generating device 410 and in which the aerosol generating space 22 is located at the distal end 14 of the device 410. A cover 46 for the aerosol generating space 22 is removably mountable on the device body 16 at the distal end 14. The cover includes air inlet ports 48, 50 which are positioned so that they direct air both to the interior of the tubular susceptor 32 and to the exterior of the tubular susceptor 32. It will be understood that this arrangement maximises the generation and delivery of aerosol from the aerosol generating space 22 along air passage 52 and through the air outlet 30.

In the aerosol generating system 4, the susceptor 32 is mounted on the cover 46 and extends from the cover 46 into the aerosol generating space 22 when the cover 46 is positioned on the device body 16 at the distal end 14 of the aerosol generating device 410 as shown in FIG. 6. Thus, the susceptor 32 is removably mounted in the aerosol generating space 22 by virtue of the removable mounting of the cover 46 on the device body 16 at the distal end 14 of the aerosol generating device 410.

With this arrangement, the susceptor 32 can be formed with the cover 46 as an integral component such that replacement of the susceptor 32 will necessitate replacement of the cover 46. Alternatively, the susceptor 32 can be removably mounted on the cover 46, for example by a connector (not shown), so that the susceptor 32 can be removed and replaced after a period of use without replacement of the cover 46.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. An aerosol generating system comprising:
an aerosol generating device comprising:
an aerosol generating space for receiving aerosol generating material;
an induction coil extending around the aerosol generating space; and
a controller;
a susceptor which is inductively heatable in the presence of a time varying electromagnetic field;
wherein the susceptor is separable from aerosol generating material located, in use, in the aerosol generating space and comprises a tubular member positioned, in use, in the aerosol generating space, and wherein the aerosol generating material is located, in use, inside and outside of the tubular member.

2. The aerosol generating system according to claim 1, wherein the susceptor is removably mounted in the aerosol generating space.

3. The aerosol generating system according to claim 1, wherein the aerosol generating device includes a connector for removably mounting the susceptor.

4. The aerosol generating system according to claim 2, wherein the controller is configured to detect the mounting of the susceptor in the aerosol generating space.

5. The aerosol generating system according to claim 1, wherein the controller is configured to detect a predetermined power level supplied to the induction coil and to indicate a timing change of the susceptor based on the detected power level.

6. The aerosol generating system according to claim 1, wherein the controller is configured to detect a predetermined power level supplied to the induction coil after positioning a susceptor in the aerosol generating space and is further configured to indicate a timing change of the susceptor based on the detected power level and/or to cease power supply to the induction coil until a replacement susceptor is positioned in the aerosol generating space.

7. The aerosol generating system according to claim 1, wherein the controller is configured to detect the consumption of aerosol generating material by detecting at least one of the following:
the number of puffs;
the length of the total puff period;
the number of placements of aerosol generating material in the aerosol generating space;
the movement of one or more components of the aerosol generating device that are required to allow the placement of aerosol generating material in the aerosol generating space.

8. The aerosol generating system according to claim 1, wherein the controller is configured to detect a predetermined level of consumption of aerosol generating material and to indicate a timing change of the susceptor based on the detected consumption level.

9. The aerosol generating system according to claim 1, wherein the controller is configured to detect a predetermined level of consumption of aerosol generating material after positioning a susceptor in the aerosol generating space and is further configured to indicate a timing change of the susceptor based on the detected consumption level and/or to cease power supply to the induction coil until a replacement susceptor is positioned in the aerosol generating space.

10. The aerosol generating system according to claim 1, wherein the susceptor is positioned in the aerosol generating space so that a longitudinal axis of the susceptor is substantially aligned with a longitudinal axis of the induction coil.

11. The aerosol generating system according to claim 1, wherein the aerosol generating space comprises a cavity.

12. The aerosol generating system according to claim 1, wherein the aerosol generating material comprises a non-liquid aerosol generating material.

13. The aerosol generating system according to claim 1, wherein the aerosol generating material comprises one or more selected from the group consisting of granules, particles, gel, strips, loose leaves, cut filler, pellets, powder, shreds, strands, foam material and sheets.

14. The aerosol generating system according to claim 1, wherein the aerosol generating material is provided in a housing connected to a mouthpiece.
